(19) United States
(12) Patent Application Publication
(10) Pub. No.: US 2026/0008937 A1
(43) Pub. Date: Jan. 8, 2026

(54) Tack Coat Formulations Containing Products Derived from Depolymerized Polymers

(71) Applicant: GreenMantra Recycling Technologies Ltd., Brantford (CA)

(72) Inventors: Benjamin Scott, Port Dover (CA); Emily Blair, Peachtree City, GA (US); John Almey, Ancaster (CA)

(21) Appl. No.: 19/258,001

(22) Filed: Jul. 2, 2025

Related U.S. Application Data
(60) Provisional application No. 63/666,977, filed on Jul. 2, 2024.

(51) Int. Cl. C09D 195/00; C09D 7/45; C09D 7/65

(52) U.S. Cl. CPC C09D 195/00; C09D 7/45; C09D 7/65

(57) ABSTRACT

Tack coat formulations can include an amount of a depolymerized wax. In some embodiments, the depolymerized wax is a polypropylene-based wax. In some embodiments, the depolymerized wax is a polyethylene-based wax. In some embodiments, the tack coat formulation is a hot applied tack coat. In some embodiments, the tack coat formulation is polymer modified tack coat. In some embodiments, the tack coat formulation is a cutback bitumen tack coat. In some embodiments, the tack coat formulation is an asphalt emulsion tack coat. In some embodiments, the tack coat is a trackless tack coat.

### CROSS-REFERENCE TO RELATED APPLICATION(S)

This application is related to and claims priority benefits from U.S. Provisional Patent Application No. 63/666,977 filed on Jul. 2, 2024, entitled “Tack Coat Formulations Containing Products Derived from Depolymerized Polymers”. The '977 application is hereby incorporated by reference herein in its entirety.

### FIELD OF THE INVENTION

The present invention relates to methods of employing polymers, oligomers, and waxes, from now on just referred to as waxes, as additives in tack coat formulations. The waxes are created from the depolymerization of plastics, including recycled plastics, including but not limited to polyethylene and/or polypropylene. The presentation also relates to methods and systems for producing and utilizing tack coat formulations with waxes.

The paving industry is actively pursuing improved sustainability and, in the US, the National Asphalt Paving Association has set a net zero carbon emission target by 2050 for new road construction and repair. In order to achieve these targets, new and novel solutions are required. One potential avenue is focused on the use of recycled plastic in paving applications and formulations. However, it is well known that the use of recycled plastic “as is” comes with numerous limitations and disadvantages, including but not limited to, poor miscibility leading to asphalt phasing of the formulations, evolution of microplastics through wear and tear, inconsistencies in the recycled plastic feedstock, and/or less predictable performance of the resulting formulations.

While work has been done on utilization of recycled plastics in the paving industry to overcome these limitations, one area of asphalt paving in particular has not explored the use of recycled plastics, namely tack coats.

Tack coats are thin bituminous liquid asphalt, emulsion, or cutback layers applied between hot mix asphalt pavement lifts to promote bonding between pavement layers, improving pavement strength, reducing surface-course sliding, and reducing top-down cracking. Tack coats can be used to ensure a strong bond between the existing asphalt and/or concrete pavement, between the layers of a structural pavement and/or at vertical surfaces that the new layer will be placed adjacent to, such as, but not limited to, curbs, gutters, utilities, and/or construction joints.

A non-track or trackless tack coat is a tack coat that is meant to be rapid setting and end with a trackless finish that ensures, or at least increases the likelihood, that there is no loss of tack coat. This aids in preventing, or at least reducing, delamination and shoving of the pavement. Typically, a trackless tack coat is an emulsified asphalt, with a faster curing time compared to a standard asphalt emulsion.

Tack coats present unique challenges in the paving industry. Insufficient adhesion between a new layer of pavement and an existing base course, a previously laid pavement layer, and/or a prepared pavement surface can cause pavement separation and cracking during construction of the structure, as well as subsequent failures and premature deterioration of the pavement structure and/or surface. Such conditions often require costly repairs, can cause damage to vehicles traveling on the surface and/or can cause dangerous traffic conditions threatening damage to property and injury to vehicles and passengers.

Poor bonding of a pavement surface layer is often a direct result of inadequate tack coat practices resulting in slippage and shoving of the pavement. Other distresses can also be made related to poor tack coat bonding, most notably pavement fatigue cracking.

Although, as discussed above, the use of recycled polymers in paving asphalt is beginning to be explored, work has not been done on how recycled polymers could be utilized in tack coats. In particular, the use of waxes created via the depolymerization of polymers in tack coat formulations has not been considered. While the use of traditional waxes with hot applied tack coats has been briefly discussed in U.S. Pat. No. 10,273,637 “Blacklidge”. Blacklidge does not discuss the use of waxes created via the depolymerization of polymers, but discusses traditional petroleum derived wax whose creation is both environmentally damaging and energy intensive. In addition, waxes created via the depolymerization of polymers, such as a catalytic depolymerization of recycled plastics, have unique properties when compared to traditional waxes due to the process by which they are created and are not simply interchangeable with traditional waxes within a given application.

Depolymerized waxes can be generated from plastic feedstocks including solid waste. A process to form synthetic waxes from solid waste is discussed in U.S. Pat. No. 8,664,458 “Kumar”. U.S. Pat. No. 8,664,458 is hereby incorporated by reference.

Methods of employing waxes produced from the depolymerization of plastic feedstocks to improve the physical properties of tack coat formulations would be beneficial. Use of waste polymers would be commercially advantageous, environmentally responsible, and offer public health benefits.

### SUMMARY OF THE INVENTION

In some embodiments, a tack coat formulation includes an amount of a depolymerized wax.

In some embodiments, the depolymerized wax is a polypropylene-based wax. In some embodiments, the depolymerized wax is a polyethylene-based wax.

In some embodiments, the tack coat formulation is a hot applied tack coat. In some embodiments, the hot applied tack coat is a polymer modified tack coat. In some embodiments, the tack coat formulation is a cutback bitumen tack coat.

In some embodiments, the tack coat formulation is an asphalt emulsion tack coat. In some embodiments, the asphalt emulsion tack coat is polymer modified.

In some embodiments, the tack coat is a trackless tack coat.

Methods and systems of creating, applying and/or using tack coat formulations containing depolymerized waxes are also disclosed.

### BRIEF DESCRIPTION OF THE DRAWING

FIG. 1 is a graph showing improved bonding performance of a tack coat modified with a wax created via the depolymerization of a polymer.

### DETAILED DESCRIPTION OF ILLUSTRATIVE EMBODIMENT(S)

Various waxes generated from plastic feedstocks can be used to modify tack coat formulations containing various elements, including but not limited to at least one depolymerized wax.

In some embodiments, the wax is made by catalytic depolymerization of polymeric material. In some embodiments, the wax is made by depolymerizing and/or thermally degrading polymeric material. In some embodiments, the catalyst used is a zeolite or alumina supported system or a combination of the two. In some embodiments, the catalyst is [Fe—Cu—Mo—P]/Al₂O₃.

In some embodiments, the catalyst is prepared by binding a ferrous-copper complex to an alumina or zeolite support and reacting it with an acid comprising metals and non-metals to obtain the catalyst material. In some embodiments, the catalyst comprises Al, Fe, Cu, and O, prepared by binding ferrous and copper complexes to an alumina and/or zeolite support. Other suitable catalyst materials include, but are not limited to, zeolite, mesoporous silica, H-mordenite and alumina.

In some embodiments, the wax is made by catalytically depolymerizing and/or thermally degrading polymeric material. In some embodiments, depolymerization can occur through the action of free radical initiators and/or the exposure to radiation.

Depolymerization processes, such as catalytic depolymerization processes, opens alternative pathways to produce the target product and these alternative pathways not only result waxes that has different functional moieties present in the polymer backbone. The aforementioned moieties present in depolymerized waxes created via a catalytic depolymerization process often include olefins (double bond) and aromatic moieties which leads to catalytic depolymerized wax having greater functionality when compared to traditional waxes. These functional differences cause the depolymerized waxes to react and behave differently when combined with other materials, such as tack coat formulations.

In some catalytic depolarization processes, the chemical pathways are also more controlled, resulting in waxes with a more uniform molecular weights.

In some embodiments, the polymeric material is polyethylene. In some embodiments, the polymeric material is polypropylene. In some embodiments, the polymeric material is polystyrene. The polymeric material can be polyethylene (PE), polypropylene (PP), polystyrene (PS), high-density polyethylene (HDPE), low-density polyethylene (LDPE), linear low-density polyethylene (LLDPE), other variations of polyethylene, or combinations of the above.

In some embodiments, the polymeric material includes both polyethylene and polypropylene material. In some embodiments, the polymeric material is divided evenly by weight between polyethylene and polypropylene. In some embodiments, the polymeric material can contain between 0% to 20% by weight PP, lower levels of polystyrene, polyethylene terephthalate (PET), ethylene-vinyl acetate (EVA), polyvinyl chloride (PVC), ethylene vinyl alcohol (EVOH), and/or undesirable additives and/or contaminants, such as fillers, dyes, metals, various organic and inorganic additives, moisture, food waste, dirt, and/or other contaminating particles.

In some embodiments, the resulting wax includes greater than 20 ppm of iron; greater than 50 ppm of zinc; and/or greater than 20 ppm of titanium as determined by x-ray fluorescence. The presence of these metals can confirm that the waxes were derived through either post-consumer or post-industrial waste polymers. In at least some embodiments, these metals also well dispersed in the resulting waxes adding both polarity and reactivity. This can make the resulting waxes more compatible in various organic and aqueous solvent formations than traditional waxes. In addition, in at least some embodiments, the added metal content can allow the resulting waxes to act as a coupling agent with other multi-polymer systems.

In other embodiments, the polymeric material includes combinations of LDPE, LLDPE, HDPE, and/or PP.

In some embodiments, the polymeric material comprises recycled plastics including, but not limited to, polyolefin, polystyrene, polyethylene, terephthalate, and/or multi-layer plastics. In other or the same embodiments, the polymeric material comprises recycled plastics and/or virgin plastics.

In some embodiments, the polymeric material includes waste polymeric material feed. Suitable waste polymeric material feeds include mixed polystyrene waste, mixed polyethylene waste, mixed polypropylene waste, and/or a mixture including mixed polyethylene waste and mixed polypropylene waste. In some embodiments, the mixed polyethylene waste can include LDPE, LLDPE, HDPE, PP, or a mixture including combinations of LDPE, LLDPE, HDPE, and/or PP. In some embodiments, the mixed polyethylene waste can include film bags, milk jugs or pouches, totes, pails, caps, agricultural film, and/or packaging material. In some embodiments, the mixed polypropylene waste can include carpet fibers, bottle caps, yogurt containers, and/or bottle labels. In some embodiments, the mixed polystyrene waste can include food packaging containers, insulation, and/or electronic packaging. In some embodiments, the waste polymeric material feed includes up to 10% by weight of material other than polymeric material, based on the total weight of the waste polymeric material feed. In some embodiments, the waste polymeric material feed includes 1% to 10% by weight of material other than polymeric material, based on the total weight of the waste polymeric material feed.

In some embodiments, the polymeric material is one of, or a combination of, virgin polyethylene (any one of, or combinations of, HDPE, LDPE, LLDPE and medium-density polyethylene (MDPE)), virgin polypropylene, post-consumer and/or post-industrial polyethylene and/or post-consumer and/or post-industrial polypropylene (exemplary sources including bags, jugs, bottles, pails, and/or other items containing PE and/or PP).

In some embodiments, the addition of the depolymerized wax changes the physical characteristics of the tack coat formulation leading to beneficial properties of the tack coat including, but not limited to:
increasing the bond strength by about 20% when compared to an unmodified tack coat formulation;
increasing the amount of sustainable/recycled material content that can be used in the tack coat;
decreasing the viscosity of the formulation allowing for lower application temperatures and better crack penetration; and/or
decreasing the gallons per square yard (gal./sq. yd.) application rate needed for the tack coat by about 50%.

In some embodiments, the tack coat formulation can include at least one depolymerized wax.

Many traditional tack coat formulations are hot applied neat performance grade bitumen. In some embodiments, the tack coat formulation is a hot applied tack coat formulation and includes a depolymerized wax. In some preferred embodiments, the same grade is used in the tack coat as used in the asphalt mix. Grades used for hot applied tack coats vary with local climate and available performance grades. The grades can include, but are not limited to, PG 64-22 and PG 67-22. However, in certain climates and regions, application of hot applied tack coats is not favored due to the higher temperatures required to apply the tack coat and/or the safety implications that come with such temperatures.

In some embodiments, the tack coat formulation is a cutback layer tack coat and includes a depolymerized wax. A cutback layer tack coat is a neat bitumen combined with a petroleum solvent. Cutbacks are used to reduce the asphalt viscosity for lower temperature applications and better crack penetration. However, the presence of the petroleum solvent results in a number of environmental disadvantages, namely solvent evaporation into the environment contributing to air pollution, the potential for the solvent leaching into the ground and waterways, especially in areas where rainfall and/or waterlogging is frequent, and/or extensive energy consumption in order to distill and collect the petroleum solvents used.

In some embodiments, the presence of at least one depolymerized wax in a hot applied tack coat formulation eliminates, or at least reduces, the need for environmentally damaging organic solvents that are leveraged in cutback bitumen tack coats.

In some embodiments, the hot applied tack coat formulation is a polymer modified bitumen tack coat. Polymer modified bitumen tack coats employ components including, but not limited to, styrene-butadiene (SB), styrene-butadiene-styrene (SBS), ethylene-vinyl acetate, polyethylene, and/or polypropylene. In some embodiments, polymer modifiers are employed in the range of 0-5% by weight of the formulation. In some embodiment where the hot applied tack coat is modified with a polymer such as SBS, the viscosity of the formulation increases which in turn requires even higher application temperatures than the standard non-polymer modified hot applied tack coat.

The presence of a depolymerized wax as an offset in a polymer modified hot applied tack coat formulation can result in a reduction in viscosity of a polymer modified hot applied tack coat allowing for a lower temperature of application which reduces the safety implications associated with a polymer modified hot applied tack coat.

In some embodiments, the tack coat formulation is an asphalt emulsion and includes a depolymerized wax. In some embodiments, asphalt emulsions include bitumen and water emulsified using an emulsifying agent. In some embodiments the emulsifying agent is a surfactant or a surface acting agent including, but not limited to, tall oil fatty acid, tallow amines, tallow diamines, gum rosin, or diethylene glycol. In some embodiments the emulsifying agent is employed in the range of 1-3% by weight of the formulation. In some embodiments the emulsifying agent is can be added at less than 1% by weight of the formulation. Asphalt emulsion-based tack coats are often used due to the benefits of being water based, having a lower viscosity allowing for lower temperature application and better crack penetration, and/or containing no volatile organic compounds/solvents present which can evaporate and/or leach into the environment.

In some embodiments the asphalt emulsion tack coat formulation is anionic. In some embodiments the asphalt emulsion tack coat formulation is cationic. In some embodiments, the asphalt emulsion tack coat formulation is non-ionic (i.e. neutral).

In some embodiments, the asphalt emulsion tack coat formulation is polymer modified with components including, but not limited to, styrene-butadiene, styrene-butadiene-styrene, ethylene-vinyl acetate, polyethylene, and/or polypropylene.

In some embodiments, the asphalt emulsion tack coat formulation is a trackless tack coat. In some embodiments the asphalt emulsion tack coat formulation is a polymer modified trackless tack coat.

In some embodiments, the percentage of bitumen in the asphalt emulsion tack coat formulation can be between and inclusive of 30-80 percent by weight. In some preferred embodiments, the percentage of bitumen in the tack coat formulation can be between and inclusive of 45-80 percent by weight. In some even more preferred embodiments, the percentage of bitumen in the tack coat formulation can be between and inclusive of 60-80 percent by weight.

In some embodiments, the percentage of depolymerized wax in the tack coat formulation can be between and inclusive of 1-20 percent by weight. In some preferred embodiments, the percentage of depolymerized wax in the tack coat formulation can be between and inclusive of 1-5 percent by weight.

In some embodiments, the depolymerized wax is a polypropylene-based wax. In some embodiments, the depolymerized wax is a polyethylene-based wax.

In some embodiments the waxes can have melting points between and inclusive of 100-170° C., viscosities between and inclusive of 20-10,000 cps, and/or acid numbers between and inclusive of 0-50 mg KOH/g. In some preferred embodiments, the wax(es) employed have melting points between and inclusive of 110-170° C., viscosities between and inclusive of 20-5,000 cps, and/or acid numbers between and inclusive of 0-34 mg KOH/g. In some more preferred embodiments, the wax(es) employed have melting points between and inclusive of 112-166° C., viscosities between and inclusive of 37.5-3000 cps, and/or acid numbers between and inclusive of 0-22 mg KOH/g. In some even more preferred embodiments, the waxes have viscosities between 100-350 cps. In some embodiments, the waxes have dropping points between 113-119° C.

Changes in melting point, viscosity, molecular weight, and/or polymer backbone structure of the wax can change the properties of the tack coat formulation. In general, addition of waxes created via the depolymerization of polymers can aid in performance and application of the tack coat by increasing the bond strength of the tack coat, and/or decreasing the application rate required to achieve a fixed bond strength.

In some embodiments, use of the depolymerized waxes can produce a stable tack coat formulation.

Changes to the wax, including but not limited to its molecular weight, and/or polymer backbone structure, can change the properties of the final tack coat formulation.

Any numerical value ranges recited herein include all values from the lower value to the upper value in increments of one unit provided that there is a separation of at least two units between any lower value and any higher value. For example, if a range is listed from 1 to 100, specifically from 30 to 70, more specifically from 40 to 50, it is intended that values such as 25 to 75, 27 to 65, 45 to 60, 32 to 37, and so on, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value are to be treated in a similar manner.

### Example 1—Tack Coat with Depolymerized Polyethylene Wax

In one example, a wax created via the depolymerization of recycled polyethylene (CERANOVUS® A115 sold by GreenMantra Technologies) was added to a commercially available bitumen (PG 64-22) and applied at a rate of 0.03 gal/yd².

TABLE 1
Composition of Tack Coat Formulations

| | | Tack Coat Formulations | |
|---|---|---|---|
| | | 1 | 2 |
| Compound | PG 64-22 | 100% | 97% |
| | CERANOVUS ® A115 | 0% | 3% |
| | (polyethylene wax) | | |

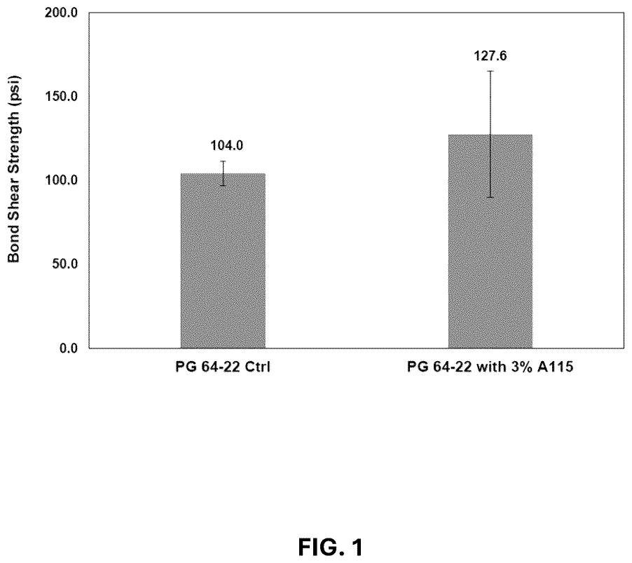

As shown in FIG. 1, the resulting formulation showed an increase in bonding strength by over 20% as measured by ALDOT 430 when compared to the unmodified hot applied tack coat.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. A tack coat formulation comprising:
an amount of a depolymerized wax.

2. The tack coat formulation of claim 1 wherein said depolymerized wax is a polypropylene-based wax.

3. The tack coat formulation of claim 1 wherein said depolymerized wax is a polyethylene-based wax.

4. The tack coat formulation of claim 1 wherein said tack coat formulation is a hot applied tack coat.

5. The tack coat formulation of claim 4 wherein said tack coat formulation is a polymer modified tack coat.

6. The tack coat formulation of claim 1 wherein said tack coat formulation is a cutback bitumen tack coat.

7. The tack coat formulation of claim 1 wherein said tack coat formulation is an asphalt emulsion tack coat.

8. The tack coat formulation of claim 7 wherein said tack coat formulation is polymer modified.

9. The tack coat formulation of claim 7 wherein said tack coat is a trackless tack coat.

10. The tack coat formulation of claim 7 wherein said formulation includes an amount of a bitumen.

11. The tack coat formulation of claim 7 wherein said formulation includes an amount of an emulsifying agent.

12. The tack coat formulation of claim 11 wherein said emulsifying agent is a surfactant.

13. The tack coat formulation of claim 11 wherein said amount of said emulsifying agent is between 1-3% by weight of said formulation.

14. The tack coat formulation of claim 10 wherein said amount of said bitumen is between 60-80% by weight of said formulation.

15. The tack coat formulation of claim 1 wherein said amount of said depolymerized wax is between 1-20% by weight of said formulation.

16. The tack coat formulation of claim 1 wherein said amount of said depolymerized wax is between 1-5% by weight of said formulation.

17. The tack coat formulation of claim 1 wherein said depolymerized wax has a melting point between and inclusive of 100-170° C.

18. The tack coat formulation of claim 16 wherein said depolymerized wax has a melting point between and inclusive of 100-170° C.

19. A method of creating a tack coat formulation, wherein said tack coat formulation comprises a wax created via depolymerization of a polymer.

20. A system of applying a tack coat formulation, wherein said tack coat formulation comprises a wax created via depolymerization of a polymer.
